(19) United States
(12) Patent Application Publication
(10) Pub. No.: US 2017/0132539 A1
(43) Pub. Date: May 11, 2017

(54) SYSTEMS AND METHODS FOR GOVERNANCE, RISK, AND COMPLIANCE ANALYTICS FOR COMPETITIVE EDGE

(71) Applicant: Tata Consultancy Services Limited, Mumbai (IN)

(72) Inventors: KELLY DENISE RAY, Krugerville, TX (US); TIMOTHY OXBOROUGH-POWELL, New York, NY (US)

(73) Assignee: Tata Consultancy Services Limited, Mumbai (IN)

(21) Appl. No.: 15/349,610

(22) Filed: Nov. 11, 2016

Related U.S. Application Data
(60) Provisional application No. 62/253,877, filed on Nov. 11, 2015.

(51) Int. Cl. G06Q 10/06

(52) U.S. Cl. CPC G06Q 10/0635; G06F 3/0481

(57) ABSTRACT

This disclosure relates generally to industry agnostic business operation analytics and more particularly to method and system for governance, risk and compliance (GRC) analytics for an enterprise. In one embodiment, the method includes generating a compliance evaluation along a scope-of-impact vector, generating a compliance evaluation along a certainty-of-enforcement vector, and generating a compliance evaluation along a significance-of-consequences vector. A graphical user interface (GUI) is constructed that pictorially represents joint compliance evaluations along the scope-of-impact vector, the certainty-of-enforcement vector, and the significance-of-consequences vector on an N-dimensional graph. A numerical value is provided corresponding to each of the evaluations along the scope-of-impact vector, the certainty-of-enforcement vector, and the significance-of-consequences vector.

### PRIORITY CLAIM

This U.S. patent application claims priority under 35 U.S.C. §119 to: US Application No. 62/253,877, filed on Nov. 11^{th} 2015. The entire contents of the aforementioned application are incorporated herein by reference.

### TECHNICAL FIELD

This disclosure relates generally to compliance risk management, and more particularly to systems and methods for governance, risk, and compliance analytics.

### BACKGROUND

Currently, organizations are increasingly aware of the legal and compliance obligations associated with their businesses, and are being encouraged by regulators to take a risk intelligent approach to compliance. Historically, when evaluating inherent and residual risk, risk officers in organizations have used a two-vector analysis that looks at the likelihood of the risk occurring as one vector of analysis and the significance of the impact as a second vector of analysis with a fairly ill-defined notion of how to measure significance of impact (traditionally called “Monte Carlo” analysis). For compliance risk, the likelihood of occurrence of a non-compliance event is more aligned to the assessment of “residual risk” taking into account the existence of controls, the suitability of their design and their actual history of performance than “inherent risk”. Accordingly, in addition to the Monte Carlo analysis performed by risk officers, additional analysis needs to be undertaken to understand “inherent compliance risk.”

Compliance officers in companies have used industry-specific methodologies for governance, risk, and compliance (“GRC”) inherent risk analysis, which cannot be easily adapted to alternate environments or scenarios. While there are methods promulgated in specific regulations and standards on capturing data for specific types of regulatory compliance risk reporting requirements, there is no generalized regulation-agnostic governance, risk, and compliance (“GRC”) enforcement analysis framework for compliance that may be applied at a strategic level.

### SUMMARY

Embodiments of the present disclosure present technological improvements as solutions to one or more of the above-mentioned technical problems recognized by the inventors in conventional systems. For example, in one embodiment, a processor-implemented method for governance, risk, and compliance (GRC) analytics for an enterprise. The method includes generating a compliance evaluation along a scope-of-impact vector, via one or more hardware processors. Further, the method includes generating a compliance evaluation along a certainty-of-enforcement vector, via the one or more hardware processors. Furthermore, the method includes generating a compliance evaluation along significance-of-consequences vector, via the one or more hardware processors. Also, the method includes constructing a graphical user interface (GUI). The GUI pictorially represents the joint compliance evaluations along the scope-of-impact vector, the certainty-of-enforcement vector, and the significance-of-consequences vector on an N-dimensional graph, via the one or more hardware processors. Also, the method includes providing a numerical value corresponding to each of the evaluations along the scope-of-impact vector, the certainty-of-enforcement vector, and the significance-of-consequences vector, via the one or more hardware processors.

In another embodiment, system for governance, risk, and compliance (GRC) analytics for an enterprise. The system includes one or more memories, and one or more hardware processors. The one or more memories coupled to the one more hardware processors, wherein the one or more hardware processors are capable of executing programmed instructions stored in the one or more memories to generate a compliance evaluation along a scope-of-impact vector, generate a compliance evaluation along a certainty-of-enforcement vector: and generate a compliance evaluation along significance-of-consequences vector. Further, the one or more hardware processors are capable of executing programmed instructions to construct a graphical user interface (GUI). The GUI pictorially representing the joint compliance evaluations along the scope-of-impact vector, the certainty-of-enforcement vector, and the significance-of-consequences vector on an N-dimensional graph. Furthermore, the one or more hardware processors are capable of executing programmed instructions to provide a numerical value corresponding to each of the evaluations along the scope-of-impact vector, the certainty-of-enforcement vector, and the significance-of-consequences vector.

In yet another embodiment, a non-transitory computer-readable medium storing instructions executable by a hardware processor to perform a method for governance, risk, and compliance (GRC) analytics for an enterprise, is provided. The method includes generating a compliance evaluation along a scope-of-impact vector, via one or more hardware processors. Further, the method includes generating a compliance evaluation along a certainty-of-enforcement vector, via the one or more hardware processors. Furthermore, the method includes generating a compliance evaluation along significance-of-consequences vector, via the one or more hardware processors. Also, the method includes constructing a graphical user interface (GUI). The GUI pictorially represents the joint compliance evaluations along the scope-of-impact vector, the certainty-of-enforcement vector, and the significance-of-consequences vector on an N-dimensional graph, via the one or more hardware processors. Also, the method includes providing a numerical value corresponding to each of the evaluations along the scope-of-impact vector, the certainty-of-enforcement vector, and the significance-of-consequences vector, via the one or more hardware processors.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network implementation for example governance, risk, and compliance analytics according to some embodiments of the present disclosure.

FIG. 2 is block diagram for a system for governance, risk, and compliance analytics according to some embodiments of the present disclosure.

FIG. 3 is a flow diagram illustrating an example governance, risk, and compliance analytics method in accordance with some embodiments.

FIG. 4 is a graphical user interface diagram illustrating regulatory enforcement characterization according to some embodiments.

FIG. 5 illustrates an exemplar set of criteria for characterizing GRC regulatory enforcement along a scope-of-compliance-impact vector, according to some embodiments.

FIG. 6 illustrates an exemplar method for normalizing aspects of characterizing GRC regulatory enforcement along a scope-of-compliance-impact vector, according to some embodiments.

FIG. 7 is a tabular diagram illustrating a multi-faceted decision framework characterizing GRC regulatory enforcement along a certainty-of-enforcement vector and a significance of impact vector, according to some embodiments.

FIGS. 8A-8C are tabular diagrams illustrating an exemplar set of sub-criteria characterizing GRC regulatory enforcement along a certainty-of-enforcement vector, according to some embodiments

FIG. 9 is a tabular diagram illustrating a multi-faceted decision framework characterizing GRC regulatory enforcement along sub-criteria indicative of a certainty-of-enforcement vector, according to some embodiments.

FIG. 10 is a tabular diagram illustrating a multi-faceted decision framework characterizing GRC regulatory enforcement along a significance-of-consequences vector, according to some embodiments.

FIGS. 11A-11C are tabular diagram illustrating an exemplar set of sub-criteria characterizing GRC regulatory enforcement along sub-criteria indicative of a significance-of-consequences vector, according to some embodiments.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Various organizations worldwide have developed practices for legal risk compliance and control. However, currently, compliance teams think in silos and fail to recognize the enforcement relevant information that can be provided by Government Affairs and Legal departments, much less the relevant meta-data that may be aggregated from other systems of record that provide insights into the significance of the impacts of compliance obligations across the firm. Compliance teams also tend to think only in terms of a limited set of governing documents (Policies and Procedures), control testing, training, and certifications as the areas impacted by regulatory change and leave an understanding of the impact on controls, processes, rules and assets (i.e., facilities, people, products, and systems) over to the business without an integrated view across the organization. Further, compliance teams tend to look at the impacts in a binary perspective of “is” or “is not” impacted, and solely the level of effort to make a change, rather than considering anything about the significance of that impact in terms of metadata regarding the objects impacted and leveraging that meta-data to choose among remediation scenarios. Additionally, there is a lack of visibility into which items impacted by a new action plan are already the subject of a pre-existing action plan.

For example, Chief Compliance Officers do not have an end-to-end view that is aligned with operations as to control ecosystem dimensions and the factors to be used in assessing the significance of regulatory compliance impacts. Further, current approaches do not consider the Geopolitical Climate, Forum, and Enforcer criteria. Current approaches generally capture consequences by nature, but not severity and reach and not in a numerical manner to facilitate broader scoring algorithms.

Embodiments of the present disclosure provide the ability for chief compliance officers to globally leverage analytics regarding the relative significance of non-compliance, scope of impact, and likelihood of regulatory enforcement for different types of regulatory obligations in strategically planning regulatory compliance program priorities and optimizing change.

For example, embodiments of the present disclosure facilitate methodologies for one or more of the following: (i) Characterizing the compliance ecosystem along key dimensions broken into value-chain dimensions, asset dimensions, and general reference data dimensions; (ii) Identifying the factors that are relevant to understanding the significance of compliance impact and change for each of those dimensions; (iii) Characterizing GRC Regulatory Enforcement for Regulatory Compliance along three vectors to feed enterprise risk management with information relevant to inherent risk assessment: a) significance of consequences; b) scope of compliance obligations; and c) likelihood of enforcement; and (iv) Aggregating all Enforcement and Significance factors into their appropriate uses for Impact Analysis and Simulation functionality for strategic planning. Further, embodiments of the present disclosure facilitate determining the relationship between the dimensions which are multi-dimensional and rendering a 2-dimensional visualization, identifying the appropriate criteria for each dimension, and determining the methodology for aggregation and normalization of significance impact ratings across dimensions.

Accordingly, embodiments of the present disclosure facilitate methodologies for modeling the relationships between:
A. Value-Chain Dimensions comprising: 1) Obligations; 2) Governing Documents; 3) Processes/Rules; 4) Training; 5) Certifications; and 6) Assessments;
B. Asset Dimensions comprising: 1) Products; 2) Legal Entities; 3) Systems; and 4) Presence (a combination of facilities and people); and
C. Reference Data Dimensions comprising: 1) Legal Subject Matter Taxonomy; 2) Structure; 3) Risks; 4) Controls; and 5) Change Management (aka Action Plans).

Embodiments of the present disclosure provide broader understanding of all aspects of the compliance ecosystem that may be impacted by change, including specific criteria characterizing the significance of the impact of change to the above mentioned dimensions. Some embodiments may present this information in a “what-if” graphical user interface (“GUI”) scenario visualization framework that communicates visually the significance of change and impact as impacted objects are identified. Some embodiments may present a “what-if” GUI simulation visualization framework that communicates visually the prospective costs of change and level of effort or duration of different remediation plan configurations. While the description that follows describes example governance, risk and compliance analytics in the context of compliance with laws and regulations, it is to be understood that the analytical framework is industry-agnostic, and can be utilized for managing risk and compliance in a variety of technical settings, e.g., in a telecommunications network, or for computer server load balancing. For example, in a telecommunications network, risks such as drop in quality of service (QoS) or denial of service (DoS) may be evaluated within the framework of the “scope of impact” vector (e.g., taking into account how many user terminals, which countries, geographical area), significance of impact” vector (e.g., taking into account extent of degradation of service, types of service degraded, availability of alternate communication forms, etc.), and the “certainty of enforcement” (e.g., taking into account economic losses, loss of consumers, regulatory action, etc.). A similar analysis may also hold for computer server load balancing. Thus, it is to be understood that the disclosed aspects may be utilized for a variety of technical objects.

Similarly, while the description that follows describes example governance, risk, and compliance analytics in the context of compliance with laws and regulations, it is to be understood that the analytical framework is industry-agnostic, and can be utilized for managing risk and compliance from a variety of compliance obligation sources. For example, in a corporate social responsibility scenario where the organization has made representations and self-imposed commitments that it has communicated to the public, risks such as failure to honor community investments in education, clean drinking water, or HIV/Malaria charitable activities may be evaluated within the framework of the “scope of impact” vector (e.g., taking into account how many schools or clinics, which countries, number of individuals impacted), significance of impact” vector (e.g., loss of life, illness, work potential, loss of government benefits tied as reciprocity for commitments, etc.), and the “certainty of enforcement” (e.g., geopolitical impact, internal program commitment, and individual leadership commitment, etc.). A similar analysis may also hold for contractual compliance and tangible/intangible asset qualifications (e.g., patents, copyrights, grants of authority, etc.). Thus, it is to be understood that the disclosed aspects may be utilized for a variety of compliance scenarios.

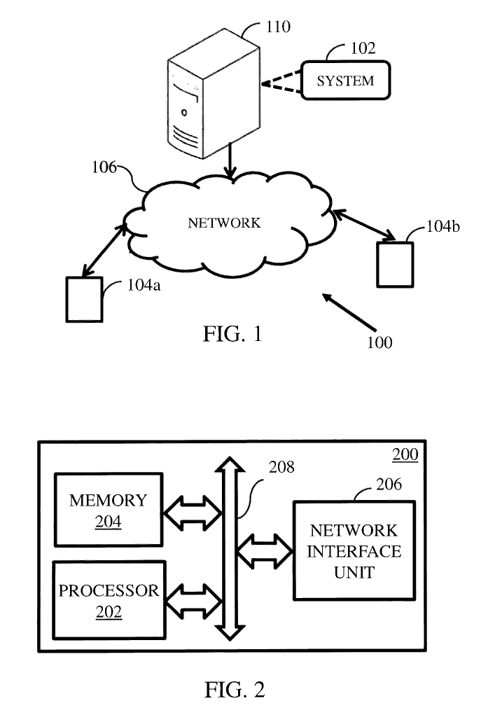

Referring now to FIG. 1, a network implementation 100 of system 102 for governance, risk, and compliance analytics is illustrated, in accordance with an embodiment of the present subject matter. The network implementation 100 is shown to include a system 102, user devices such as user devices 104-1, 104-2 . . . 104-N, and a communication network 106 for facilitating communication between the system 102 and the user devices 104-1, 104-2 . . . 104-N.

The system 102 facilitates in characterizing the GRC regulatory enforcement for regulatory compliance, along a first vector corresponding to a significance of impact if non-compliant, along a second vector corresponding to certainty of enforcement, and along a third vector corresponding to a scope of impact across the firm/organization. Further the system 102 may generate a joint visualization of the characterizations along each vector in a two dimensional graphical user interface (“GUI”). In addition, the system 102 may assign a point or value scale for characterizing each of a set of criteria and sub-criteria for each vector and assign guidance on application of the point scale to each of a set of criteria and sub-criteria for each vector. The system may identify values for each of the characterized first, second, and third vectors, and adapt a representation of three vectors to the available 2-dimension or N-dimension visualization used in the target framework. The system may then provide the identified values for the first, second, and third vectors for data processing such as a project prioritization framework. Further, the system 102 may provide the identified values for each of the first, second, and third vectors to a risk management framework.

Herein, although the present subject matter is explained considering that the system 102 is implemented for governance, risk, and compliance analytics, it may be understood that the system 102 may not restricted to any particular machine or environment. The system 102 may be implemented in a variety of computing systems, such as a laptop computer, a desktop computer, a notebook, a workstation, a mainframe computer, a server, a network server, and the like.

The devices 104 are communicatively coupled to the system 102 through a network 106, and may be capable of transmitting the signals to the system 102. In one implementation, the network 106 may be a wireless network, a wired network or a combination thereof. The network 106 can be implemented as one of the different types of networks, such as intranet, local area network (LAN), wide area network (WAN), the Internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In an embodiment, the system 102 may be embodied in a computing device 110. Examples of the computing device 110 may include, but are not limited to, a desktop personal computer (PC), a notebook, a laptop, a portable computer, a smart phone, a tablet, and the like. An example implementation of the system 102 for continuous compliance portfolio prioritization is described further with reference to FIG. 2.

FIG. 2 a block diagram of a system 200 for governance, risk, and compliance analytics, in accordance with an embodiment of the present disclosure. In an example embodiment, the system 200 may be embodied in, or is in direct communication with a computing device, for example the computing device 110 (FIG. 1). The system 200 includes or is otherwise in communication with one or more hardware processors such as a processor 202, one or more memories such as a memory 204, and a network interface unit such as a network interface unit 206. In an embodiment, the processor 202, memory 204, and the network interface unit 206 may be coupled by a system bus such as a system bus 208 or a similar mechanism.

The processor 202 may include circuitry implementing, among others, audio and logic functions associated with the communication. For example, the processor 202 may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. The processor 202 thus may also include the functionality to encode messages and/or data or information. The processor 202 may include, among other things, a clock, an arithmetic logic unit (ALU) and logic gates configured to support operation of the processor 202. Further, the processor 202 may include functionality to execute one or more software programs, which may be stored in the memory 204 or otherwise accessible to the processor 202.

The one or more memories such as a memory 204, may store any number of pieces of information, and data, used by the system to implement the functions of the system. The memory 204 may include for example, volatile memory and/or non-volatile memory. Examples of volatile memory may include, but are not limited to volatile random access memory (RAM). The non-volatile memory may additionally or alternatively comprise an electrically erasable programmable read only memory (EEPROM), flash memory, hard drive, or the like. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the system 200 to carry out various functions in accordance with various example embodiments. Additionally or alternatively, the memory 204 may be configured to store instructions which when executed by the processor 202 causes the system 200 to behave in a manner as described in various embodiments.

The network interface unit 206 is configured to facilitate communication between the devices and the computing device 110. The network interface unit 206 may be in form of a wireless connection or a wired connection. Examples of wireless network interface unit 206 may include, but are not limited to, IEEE 802.11 (Wi-Fi), BLUETOOTH®, or a wide-area wireless connection. Example of wired network interface element 206 includes, but is not limited to Ethernet.

The system 200 may be caused to generate, via the hardware processor, a compliance evaluation along a scope-of-impact vector. In an embodiment, the scope of compliance obligations may be characterized according to a number of dimensions 310, such as structure, presence, products, legal entities, obligations, governing documents, controls, processes/rules, systems, training, and assessments and certifications

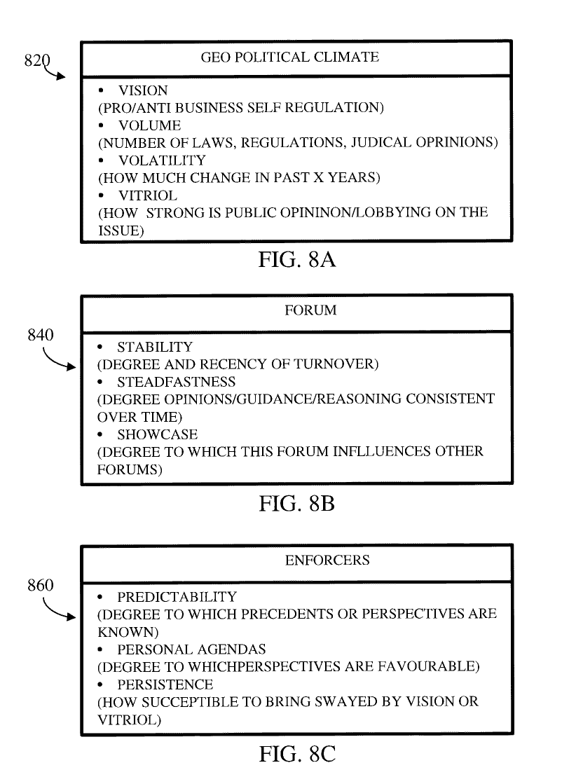

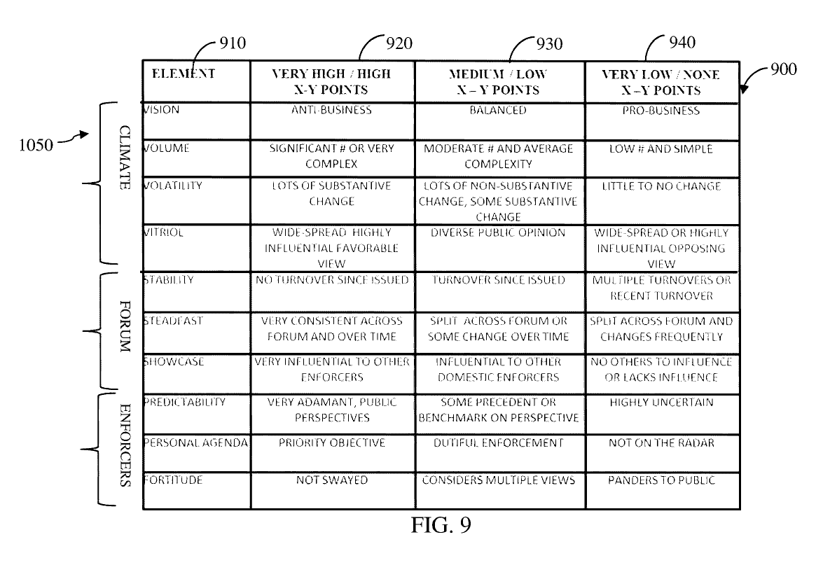

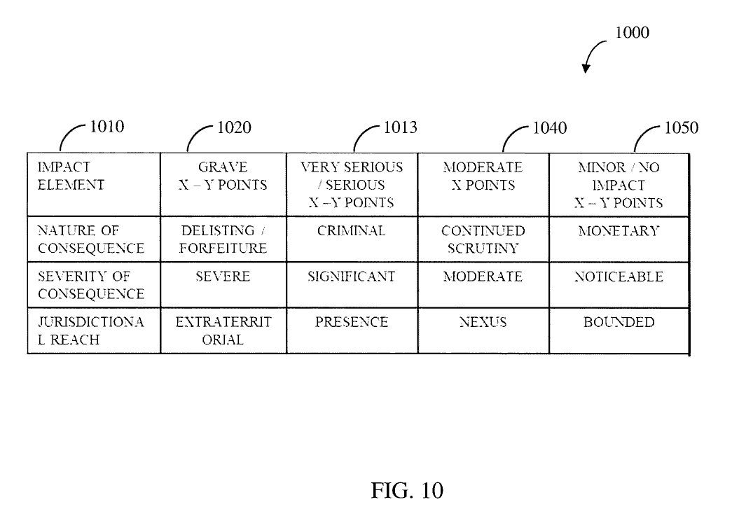

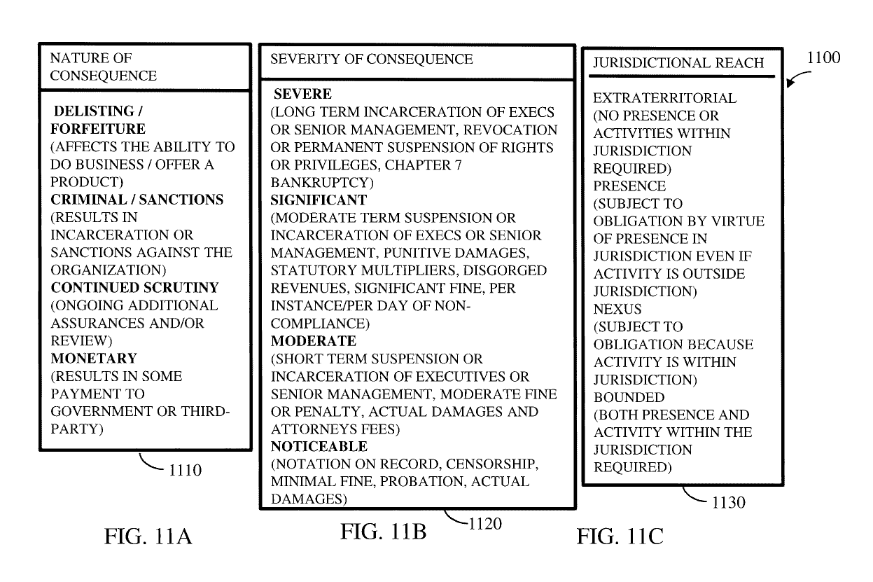

The system 200 may be caused to generate a compliance evaluation along a certainty-of-enforcement vector, via the hardware processor. An example of characterizing GRC regulatory enforcement along a certainty-of-enforcement vector is described further with reference to FIGS. 8A-8C and 9. The system 200 may be caused to generate a compliance evaluation along a significance-of-consequences vector, via the hardware processor. An example of generate a compliance evaluation along a significance-of-consequences vector is described further with reference to FIGS. 10 and 11A-11C.

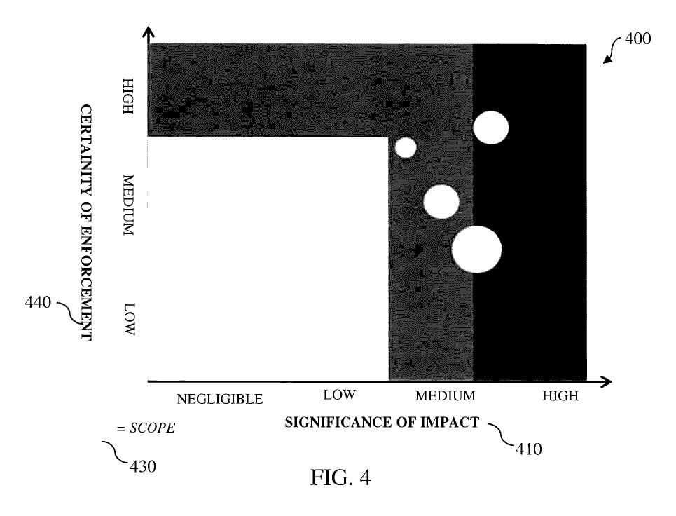

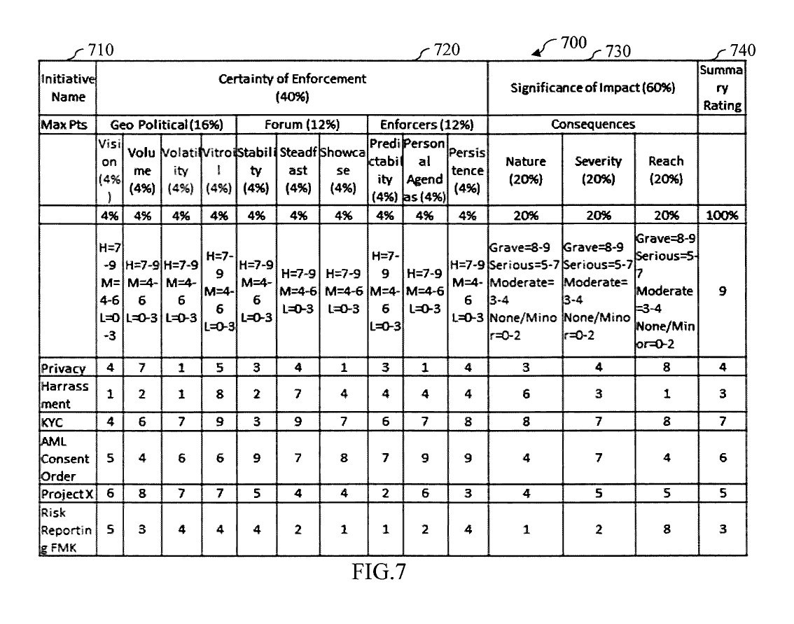

The system 200 may be caused to construct an N-dimensional graphical user interface such that the graphical user interface pictorially depicting the compliance evaluations along the scope-of-impact vector, the certainty-of-enforcement vector, and the significance-of-consequences vector on the N-dimensional graph. The system may be caused to construct the GUI via the hardware processor. In an embodiment, the N-dimensional graph may be a 2-dimensional (2D) graph. An example of the 2D GUI is described further with reference to FIG. 4. The system 200 may be caused to provide a numerical value corresponding to each of the evaluations along the scope-of-impact vector, the certainty-of-enforcement vector, and the significance-of-consequences vector, via the hardware processor. An example of providing the numerical values corresponding to the evaluations along the first, second and the third vectors is described further with reference to FIG. 7.

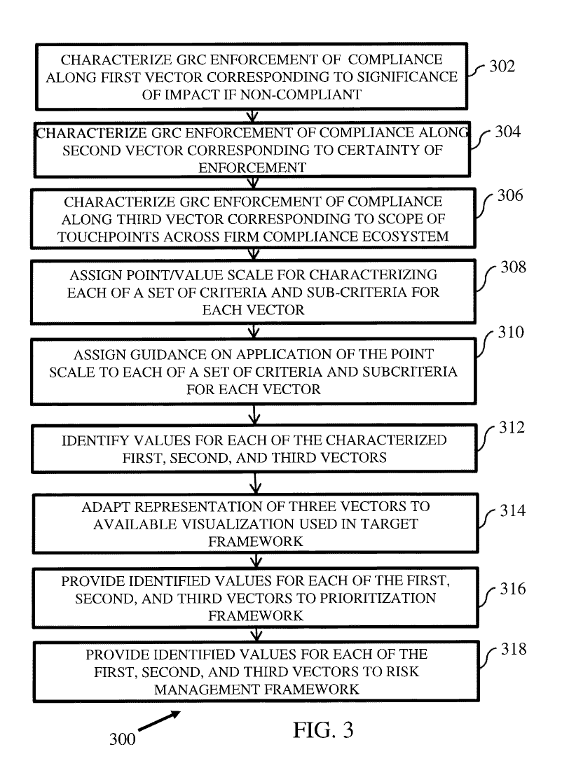

FIG. 3 is a flow diagram of a method 300 for governance, risk, and compliance analytics in accordance with some embodiments. In method 300, at step 302, the computing system may characterize the GRC regulatory enforcement for regulatory compliance, along a first vector corresponding to a significance of impact if non-compliant. At step 304, a computing system may characterize the GRC regulatory enforcement for regulatory compliance, along a second vector corresponding to certainty of enforcement. In method 300, at step 306, a computing system may characterize a governance, risk, and compliance (“GRC”) regulatory enforcement for regulatory compliance, along a third vector corresponding to a scope of impact across the firm. The computing system may generate a joint visualization of the characterizations along each vector in a two dimensional graphical user interface (“GUI”).

At step 308, the computing system may assign a point or value scale for characterizing each of a set of criteria and sub-criteria for each vector. At step 310, the computing system may assign guidance on application of the point scale to each of a set of criteria and sub-criteria for each vector. At step 312, the computing system may identify values for each of the characterized first, second, and third vectors. At step 314, the computing system may adapt the representation of three vectors to the available 2-dimension or N-dimension visualization used in the target framework. At step 316, the computing system may provide the identified values for the first, second, and third vectors for data processing such as a project prioritization framework. At step 318, the computing system may provide the identified values for each of the first, second, and third vectors to a risk management framework.

FIG. 4 is a graphical user interface diagram, GUI 400, illustrating regulatory enforcement characterization according to some embodiments. In GUI 400, a two-dimensional map may be presented. In some embodiments, the map may include a two-axis graph, with each axis representing a different vector along which GRC regulatory enforcement is characterized. For example, the x-axis 410 of the graph may correspond to the “significance of impact” vector, and the y-axis 420 of the graph may correspond to the “certainty of enforcement” vector. The two-dimensional graph may be divided into zones, such as “negligible,” “low” (e.g., moderate), “medium” (e.g., serious), “high” (e.g., grave) representing areas within the two-axis graph. Each set of regulatory obligations may be represented by a bubble within this 2-axis graph. For example, the set of regulatory obligations encompassed by bubble 440 presents low significance of impact and low certainty of enforcement, whereas the set of regulatory obligations encompassed by bubble 450 presents a medium-to-high significance of impact and medium certainty of enforcement. Further, the size 430 of each bubble may represent a “scope of compliance impact” vector, with a larger bubble representing a greater scope of compliance impact than a smaller bubble.

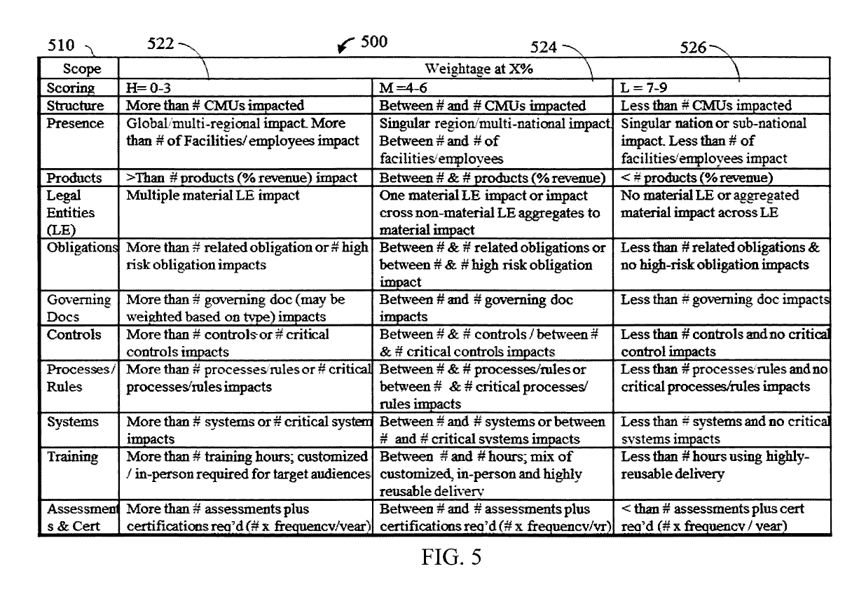

FIG. 5 illustrates an exemplar set of criteria characterizing GRC regulatory enforcement along a scope-of-compliance-obligations vector, according to some embodiments. In table 500, the scope of compliance obligations may be characterized according to a number of dimensions 510, such as structure, presence, products, legal entities, obligations, governing documents, controls, processes/rules, systems, training, and assessments and certifications. The table 300 may specify rules or metrics according to which the scope of obligations may be classified as high, medium, or low along each dimension of scope. As an example in a weighting column 520, the table 300 may include sub-columns 522, 524, and 526 corresponding to rules specifying metrics for classification of a scope along a dimension as high, medium, or low. For example, the scope of obligations may be considered high in a “products” dimension if the number of products (by % of revenue) is greater than a threshold, or medium if between a range of thresholds, or low if below a lower threshold.

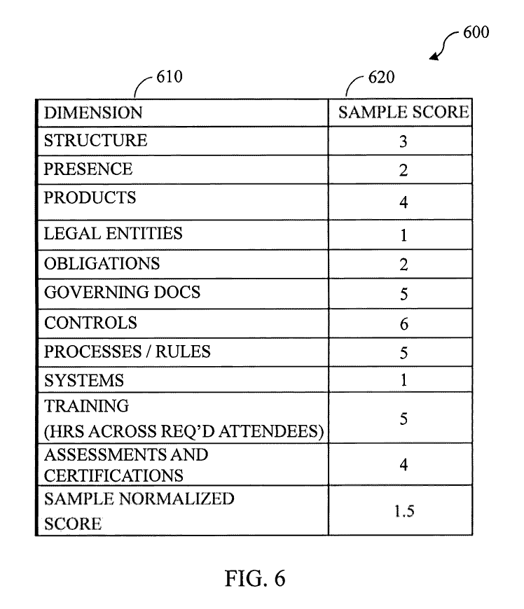

FIG. 6 is a block diagram illustrating additional aspects of characterizing GRC regulatory enforcement along a scope-of-compliance-impact vector, according to some embodiments. In some embodiments, the classification of scope along each dimension 610 may be converted into a numerical quantity 420 (e.g., “high”=3; “medium”=2; and “low”=1), and thus the scope of obligations may be provided a score along each dimension. The overall scope of regulatory obligations may then be normalized based on the dimensional scores (e.g., as a weighted sum of the dimensional scores), a median, or other normalization methodology.

FIG. 7 illustrates a multi-faceted decision framework characterizing GRC regulatory enforcement along a certainty-of-enforcement vector and a significance of impact vector, according to some embodiments. In some embodiments, a set of regulatory obligations may be evaluated according to a certainty-of-enforcement vector and a significance of impact vector. In table 700, the regulatory obligations may be characterized according to a number of dimensions 710, such as privacy, harassment, etc., indicative, for example, of a type of enforcement action. For each type of enforcement action, table 700 may rate the certainty of enforcement 720 along a number of parameters, such as a geo-political rating (e.g., based on the sovereign or country in which enforcement is to take place), a rating against the forum of enforcement (e.g., the forum in which the enforcement action will take place), and a rating against the enforcer of the regulatory obligation. Based on these parameters, a summary enforcement rating 740 for each type of enforcement action may be developed. Similarly, for each type of enforcement action, table 700 may rate the significance of impact 730 along one or more parameters, such as a consequences rating. Based on the parameter(s), a summary significance rating 740 for each type of enforcement action may be developed.

FIGS. 8A-80 illustrates exemplar sets of sub-criteria characterizing GRC regulatory enforcement along a certainty-of-enforcement vector, according to some embodiments. With reference to FIG. 8A, in some embodiments, the geo-political rating may depend in part on a number of factors 820, such as the geo-political climate, including the vision of political leadership, volume of legal requirements, volatility of the political environment, and vitriol of the public opinion. With reference to FIG. 8B, in some embodiments, the forum rating may depend in part on a number of factors 840, such as stability of the forum (e.g., degree and recency of turnover of officials), adherence to consistent reasoning, and influence of the forum. With reference to FIG. 8C, in some embodiments, the enforcer rating may depend in part on a number of factors 860, such as their predictability, personal agendas, and persistence (susceptibility to influence).

FIG. 9 illustrate a multi-faceted decision framework of additional aspects of characterizing GRC regulatory enforcement along a certainty-of-enforcement vector, according to some embodiments. In some embodiments, a table 900 may aggregate information related to the parameters listed in FIGS. 8A-8C. For example, table 900 may include rows corresponding to the geo-political climate, forum, and enforcers (see 950). Against each of the geo-political climate, forum, and enforcers classes, multiple rows may lists the parameters relevant to each row (see 910). The set of regulatory obligations may be rated as high (920), medium (930), or low (940), against each parameter based on criteria listed in columns 920, 930, and 940.

FIG. 10 illustrates a multi-faceted decision framework characterizing GRC regulatory enforcement along a significance-of-consequences vector, according to some embodiments. In some embodiments, a set of regulatory obligations may be evaluated according to a significance of consequences vector. In table 1000, the regulatory obligations may be characterized according to a number of dimensions 1010, such as the nature of the consequence, the severity of the consequence, and the jurisdictional reach. Table 1000 may rate each dimension of evaluation, and assign scores accordingly, as grave 1020 (score: 8-9 points), very serious 1030 (score: 5-7 points), moderate 1040 (score: 3-4 points), or minor 1050 (score: 0-2 points) based on criteria listed in columns 1020, 1030, 1040, and 1050.

FIG. 11 illustrates an exemplar set of sub-criteria characterizing GRC regulatory enforcement along a significance-of-consequences vector, according to some embodiments. In some embodiments, each dimension according to which the significance-of-consequences vector is evaluated may be assigned a number of different values. For example, the nature of consequences 1110 may take values like delisting/forfeiture, sanctions, etc. The severity of consequences 1120 may take values like “severe,” “significant,” “moderate,” or “noticeable.” The jurisdictional reach 1130 parameters may take values like “extraterritorial,” “presence,” “nexus,” or “bounded.”

### Computer System

The specification has described systems and methods for governance, risk, and compliance analytics. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor-implemented method for governance, risk, and compliance (GRC) analytics for an enterprise, the method comprising:
generating a compliance evaluation along a scope-of-impact vector, via one or more hardware processors;
generating a compliance evaluation along a certainty-of-enforcement vector, via the one or more hardware processors;
generating a compliance evaluation along significance-of-consequences vector, via the one or more hardware processors;
constructing a graphical user interface (GUI), the GUI pictorially representing the joint compliance evaluations along the scope-of-impact vector, the certainty-of-enforcement vector, and the significance-of-consequences vector on a N-dimensional graph, via the one or more hardware processors; and
providing a numerical value corresponding to each of the evaluations along the scope-of-impact vector, the certainty-of-enforcement vector, and the significance-of-consequences vector, via the one or more hardware processors.

2. The method of claim 1, further comprising
characterizing the GRC with a plurality of dimensions comprising value-chain dimensions, asset dimensions, and general reference data dimensions; and
identifying one or more factors associated with compliance impact and change for each of the one or more dimensions along the scope-of-impact vector, the certainty-of-enforcement vector, and the significance-of-consequences vector.

3. The method of claim 2, wherein the value chain dimensions comprises: one or more of obligations, governing documents, processes/rules; trainings, certifications; and assessments.

4. The method of claim 2, wherein the asset dimensions comprises products, legal entities, systems, and presence of facilities and people.

5. The method of claim 2, wherein the reference data dimensions comprises legal subject matter taxonomy, structure, risks, controls, and change management.

6. The method of claim 1, wherein the GUI is capable of communicating visually one or more of prospective costs of change, level of effort, and duration of different remediation plan configurations.

7. The method of claim 2, wherein providing a numerical value corresponding to each of the evaluations comprises:
assigning guidance on application of a point scale to each of a set of criteria and a set of sub-criteria for each of the scope-of-impact vector, certainty-of-enforcement vector, and significance-of-consequences vector;
identifying values for each of the characterized first, second, and third vectors; adapting the representation of the scope-of-impact vector, certainty-of-enforcement vector, and significance-of-consequences vector to a visualization; and
providing the identified values for the scope-of-impact vector, certainty-of-enforcement vector, and significance-of-consequences vector for data processing.

8. A system for governance, risk, and compliance (GRC) analytics for an enterprise, the system comprising:
one or more memories; and
one or more hardware processors, the one or more memories coupled to the one or more hardware processors, wherein the one or more hardware processors are capable of executing programmed instructions stored in the one or more memories to:
generate a compliance evaluation along a scope-of-impact vector;
generate a compliance evaluation along a certainty-of-enforcement vector;
generate a compliance evaluation along significance-of-consequences vector;
construct a graphical user interface (GUI), the GUI pictorially representing the joint compliance evaluations along the scope-of-impact vector, the certainty-of-enforcement vector, and the significance-of-consequences vector on an N-dimensional graph; and
provide a numerical value corresponding to each of the evaluations along the scope-of-impact vector, the certainty-of-enforcement vector, and the significance-of-consequences vector.

9. The system of claim 8, wherein the one or more hardware processors are capable of executing programmed instructions to:
characterize the GRC with a plurality of dimensions comprising value-chain dimensions, asset dimensions, and general reference data dimensions; and
identify one or more factors associated with compliance impact and change for each of the one or more dimensions along the scope-of-impact vector, the certainty-of-enforcement vector, and the significance-of-consequences vector.

10. The system of claim 9, wherein the value chain dimensions comprises one or more of obligations, governing documents, processes/rules, trainings, certifications and assessments.

11. The system of claim 9, wherein the asset dimensions comprises products, legal entities, systems, and presence of facilities and people.

12. The system of claim 9, wherein the reference data dimensions comprises legal subject matter taxonomy, structure, risks, controls, and change management.

13. The system of claim 8, wherein the GUI is capable of communicating visually one or more of prospective costs of change, level of effort, and duration of different remediation plan configurations.

14. The system of claim 9, wherein providing a numerical value corresponding to each of the evaluations comprises:
assigning guidance on application of a point scale to each of a set of criteria and a set of sub-criteria for each of the scope-of-impact vector, certainty-of-enforcement vector, and significance-of-consequences vector;
identifying values for each of the characterized first, second, and third vectors; adapting the representation of the scope-of-impact vector, certainty-of-enforcement vector, and significance-of-consequences vector to a visualization; and
providing the identified values for the scope-of-impact vector, certainty-of-enforcement vector, and significance-of-consequences vector for data processing.

15. A non-transitory computer-readable medium storing instructions executable by a hardware processor to perform a method for governance, risk, and compliance (GRC) analytics for an enterprise, the method comprising:
generating a compliance evaluation along a scope-of-impact vector;
generating a compliance evaluation along a certainty-of-enforcement vector;
generating a compliance evaluation along significance-of-consequences vector;
constructing a graphical user interface (GUI), the GUI pictorially representing the joint compliance evaluations along the scope-of-impact vector, the certainty-of-enforcement vector, and the significance-of-consequences vector on an N-dimensional graph; and
providing a numerical value corresponding to each of the evaluations along the scope-of-impact vector, the certainty-of-enforcement vector, and the significance-of-consequences vector.
